(19) United States
(12) Patent Application Publication
(10) Pub. No.: US 2010/0170340 A1
(43) Pub. Date: Jul. 8, 2010

(54) CLAMPING FLANGE

(75) Inventor: Dirk Warkotsch, Burgwedel (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: HAWEKA AG, Burgwedel (DE)

(21) Appl. No.: 12/529,855

(22) PCT Filed: Mar. 3, 2008
(86) PCT No.: PCT/EP2008/001663

§ 371 Date: Sep. 3, 2009

(30) Foreign Application Priority Data
Mar. 3, 2007 (DE) 10 2007 010 836.4

(51) Int. Cl. G01M 1/02

(52) U.S. Cl. 73/487

(57) ABSTRACT

A clamping flange that is designed to press a rim of a vehicle wheel against a flange of a shaft of a balancing machine and has a clamping plate with a plurality of recesses for accommodating centering bolts and a central opening to be slid onto the shaft of the balancing machine. The centering bolts can be inserted into the front of the clamping plate. The clamping flange is slidable onto the shaft while a clamping arrangement is provided for centering the clamping flange on the shaft. The clamping arrangement encompasses a clamping sleeve which is mounted in the central opening so as to be movable in an axial direction relative to the clamping plate. The clamping sleeve is movble into a clamping position by applying a pressure acting in an axial direction. In the clamping position, the clamping sleeve is mounted without play on the shaft and clamping flange.

### BACKGROUND OF THE INVENTION

1. Field of Invention

The invention relates to a clamping flange designed to press a rim of a vehicle wheel against a flange of a shaft of a wheel balancing machine, with a clamping plate having a plurality of recesses for receiving centering bolts, and a central aperture for pushing onto the shaft of the wheel balancing machine, wherein the centering bolts can be inserted into the clamping plate on a front side, wherein the clamping flange can be pushed onto the shaft, and wherein a gripping arrangement for the middle centering of the clamping flange on the shaft is provided.

2. Description of Related Art

Clamping devices for clamping wheels of different types of motor vehicles onto a shaft of a wheel balancing machine are known from the prior art. The known clamping devices have a clamping flange with a central aperture for axially guiding the rim of a vehicle wheel of a shaft. Furthermore, a plurality of groups of recesses for receiving centering bolts are arranged in the clamping flange. The centering bolts are fixed releasably in a group of recesses in accordance with the arrangement of holes in the rim of a vehicle wheel which is to be clamped. An end portion of said centering bolts engages in the fastening holes, which serve for centering purposes, in the rim of the vehicle wheel. By means of a clamping nut which is placed onto the shaft, the rear side of the vehicle wheel or rim is brought to bear tightly against a bearing flange of the wheel balancing machine. The bearing flange aligns the rim in a plane perpendicular to the axis of the wheel balancing machine, and the centering bolts, which engage in the centering or fastening holes in the rim of the vehicle wheel, center said rim radially.

DE 38 08 755 A1 corresponds to U.S. Pat. No. 4,918,986 discloses a clamping device of the previously described type, which has a cone arrangement for the middle centering of the rim of the vehicle wheel on the shaft. In order to center the rims on the shaft, the cone arrangement is designed in the manner of a collet chuck with an inner and an outer part, the outer part having an outer cylindrical surface for engagement in a centering bore in the rim of the vehicle wheel. The inner and the outer parts are arranged displaceably relative to each other such that the inner part is placed in a play-free manner onto the spindle while the cylindrical outer surface of the outer part of the collet chuck comes to bear in a play-free manner against the inner surface of the centering hole in the rim. In spite of a play-free and centered arrangement of the rim on the shaft of the wheel balancing machine, centering and wheel balancing errors during the wheel balancing operation with the known clamping device cannot be completely ruled out.

Centering and wheel balancing errors can also be attributed to play being present between the clamping flange of the clamping device and the shaft. German Patent Application DE 103 31 129 A1 and corresponding U.S. Pat. No. 7,010,975 B2 disclose a clamping flange for a clamping device in which a central aperture in a clamping plate of the clamping flange is bounded, at least in some sections, by an elastically deformable wall region of the clamping plate that also bounds a pressure space which is filled with a fluid. By means of an adjustable pressure element which is likewise arranged in the pressure space and acts on the fluid, an internal pressure on the wall region can be adjusted in the pressure space. As a function of the internal pressure, the wall region is deformed elastically such that the wall region comes to bear in a play-free manner against the shaft. Centering and wheel balancing errors due to play between the clamping flange and the shaft should thereby be reduced. The wall region is deformed in the functional position or the centering position of the clamping flange, i.e., in a position in which it is arranged on the shaft. However, the deformation of the wall region of the known clamping flange is complicated structurally and leads to high production costs of the clamping flange. Although the play between the clamping flange and the shaft can be reduced by the deformation of the wall region, it cannot be completely avoided. Furthermore, the internal pressure regulation necessary for the elastic deformation of the wall region in the pressure space of the clamping flange is complicated.

### SUMMARY OF THE INVENTION

It is the object of the present invention to provide a clamping flange of the type mentioned at the beginning which, in order to avoid centering and unbalance errors during a wheel balancing operation, can be centered in a play-free manner on the shaft even in the event of different tolerances between the clamping flange and the shaft and even in the event of increasing wear.

Furthermore, it is also the object of the present invention to provide a clamping flange which is designed in a structurally simple manner and permits centering on the shaft in a simple manner and with a high degree of accuracy.

The abovementioned objects are achieved in the case of a clamping flange of the type mentioned initially above in that the gripping arrangement has a gripping sleeve which is mounted in the central aperture in a manner such that it is displaceable in the axial direction relative to the clamping plate, wherein the gripping sleeve can be displaced by a compressive force acting in the axial direction being applied and can be transferred into a gripping position, and wherein the gripping sleeve is mounted in the gripping position in a play-free manner on the shaft and on the clamping flange.

The invention is based on the basic concept of the centering of the clamping flange no longer being undertaken by means of a deformation of the wall region of the clamping plate in the region of the central recess, which deformation is complicated structurally and in terms of regulation, but rather by the provision of a gripping sleeve which is displaceable relative to the clamping plate and by means of which the clamping flange is mounted in a play-free manner on the shaft in the gripping state of the gripping sleeve. The compressive force or clamping force required for the displacement relative to the clamping flange can be applied to the gripping sleeve via a quick-acting clamping nut or the like.

By means of the gripping sleeve, the play present in the release position of the gripping sleeve between the clamping flange and the shaft is reduced in the gripping state to such an extent that essentially no imbalance errors can occur during the wheel balancing operation. In this case, the term “play-free” is also understood as meaning a state in which the play between the clamping flange and the shaft is reduced in the gripping state in relation to the play which is present when the gripping sleeve is arranged in the release position, but is not completely ruled out. However, when the gripping sleeve is arranged in the gripping position, it is preferred for no play at all to be present.

The play-free mounting of the clamping flange on the shaft that is provided in the gripping state of the gripping sleeve signifies, firstly, that there is no play between the clamping flange and the shaft. In this connection, the invention permits a substantially play-free, axial displaceability of the clamping flange in the circumferential direction. However, it is preferably provided that the gripping sleeve bears frictionally against the shaft in the gripping state. With the frictional connection, any play between the clamping flange and the shaft can be ruled out, and an axial displacement of the clamping flange relative to the shaft is no longer possible. As a result, even in the event of different tolerances between the central recess in the clamping plate and the shaft, and even as the wear of the clamping flange increases, the gripping sleeve ensures a permanent and simply controllable centering function of the clamping flange on the shaft.

Furthermore, the gripping sleeve can be connected releasably to the clamping flange such that the gripping sleeve can be exchanged as a function of the state of wear thereof. Furthermore, the gripping sleeve can be manufactured from a material which has a high degree of abrasion resistance. This ensures a long-lasting option for fitting the clamping flange on the shaft in a play-free manner and for the middle centering thereof

In detail, there are a multiplicity of options for designing the clamping flange according to the invention, as will be apparent from the detailed description below in conjunction with the accompanying drawings.

### BRIEF DESCRIPTION OF THE DRAWINGS

FIG. 1 is an exploded perspective view of a clamping flange according to the invention,

FIG. 2 is an exploded perspective view showing the clamping flange of FIG. 1, in a partially fitted state,

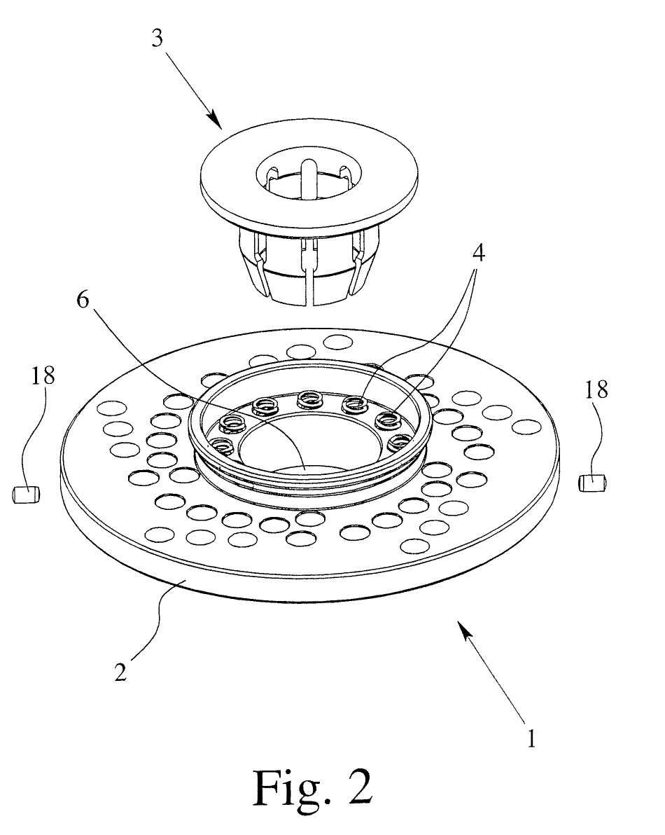

FIG. 3 is a cross-sectional view of the clamping flange of FIG. 1 in a state fitted onto a shaft of a wheel balancing machine, and

FIG. 4 is a cross-sectional view of a gripping sleeve for the fitting in and centering the clamping flange of FIG. 1 on a shaft of a wheel balancing machine.

### DETAILED DESCRIPTION OF THE INVENTION

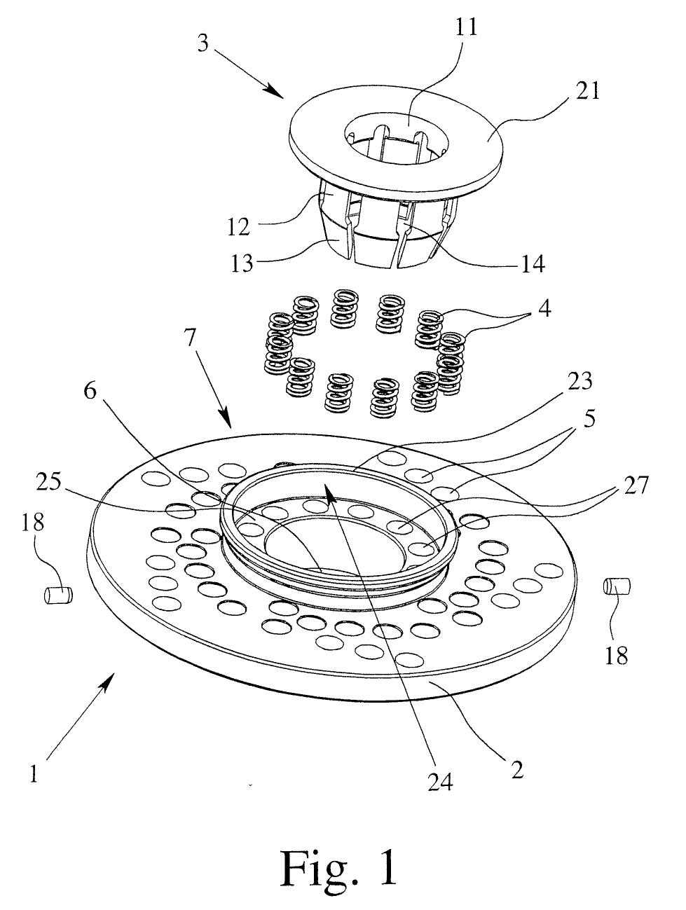

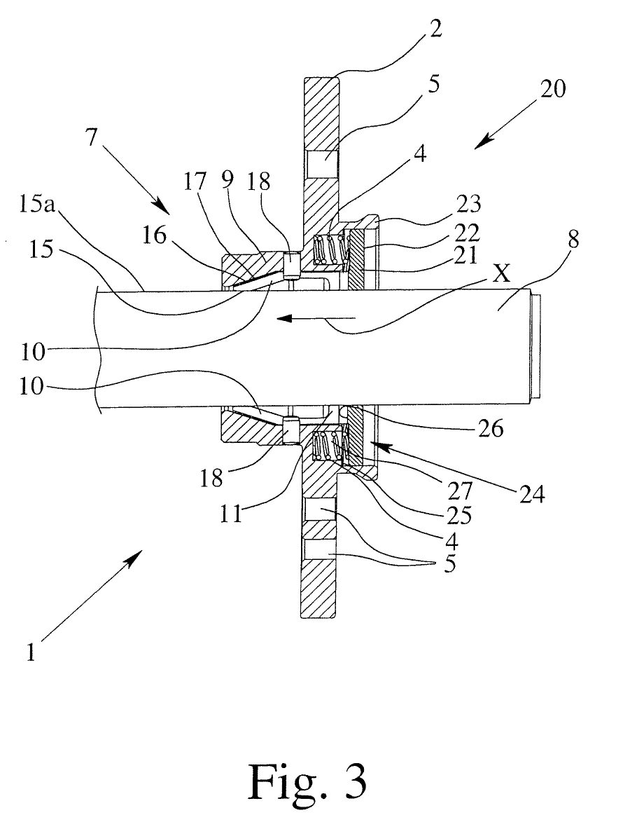

FIG. 1 shows a clamping flange 1 with a clamping plate 2, a gripping sleeve 3 and a plurality of springs 4, the clamping flange 1 being designed to press a rim of a vehicle wheel against a flange (not illustrated) of a shaft 8 (FIG. 3) of a wheel balancing machine. For this purpose, the clamping plate 2 is provided with a plurality of recesses 5 for receiving centering bolts (not illustrated) and with a central aperture 6 for mounting on the shaft 8 of the wheel balancing machine, the centering bolts being insertable into the clamping plate 2 on a front side 7 of the clamping flange 1, and the gripping sleeve 3 being the gripping part of a gripping arrangement which is designed for fitting the clamping flange 1 on the shaft and for the play-free centering of the clamping flange 1 on the shaft.

The gripping sleeve 3 is displaceable in the axial direction with respect to the clamping plate 2 and is mounted on the clamping plate 2, the clamping flange 1 being pushable onto the shaft 8 by the gripping sleeve 3 with play in a release position of the gripping sleeve 3. By a compressive force being applied to the gripping sleeve 3, the gripping sleeve 3 can be displaced in the axial direction relative to the clamping plate 2 and transferred into a gripping position in which the gripping sleeve 3 bears with a radial gripping portion at the front end of the gripping sleeve 3 in a play-free manner against the shaft 8 in the gripping position, and preferably, forms a frictional connection with the shaft 8. This is discussed in detail below.

As emerges in particular from FIG. 3, in the mounted state of the clamping flange 1, the gripping sleeve 3 is inserted displaceably in the central aperture 6 and is mounted on the clamping plate 2, and the clamping flange 1 is pushed by the gripping sleeve 3 onto the shaft 8 of the wheel balancing machine. In FIG. 3, the gripping sleeve 3 is in the release position in which the clamping flange 1 can be displaced on the shaft 8 with play in the axial direction and can be rotated about the shaft 8.

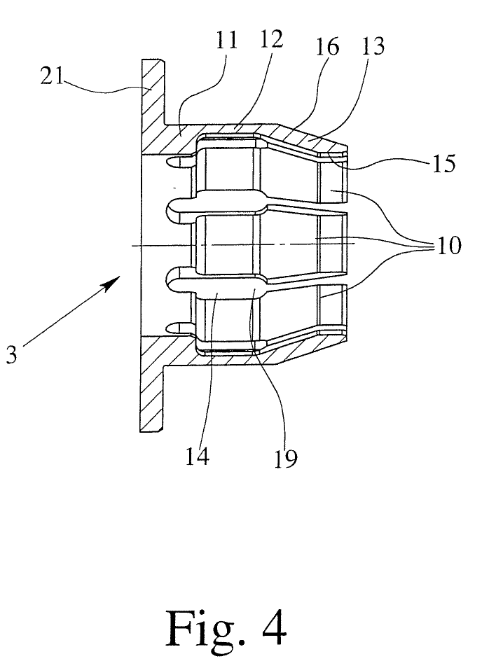

An annular centering extension 9 of the clamping plate 2, which centering extension is arranged coaxially with respect to the central aperture 6, is provided on the front side 7 of the clamping flange 1 as a guide for the gripping sleeve 3. In this case, the gripping sleeve 3 is mounted displaceably in the centering extension 9 such that the gripping sleeve 3 can be displaced from the release position, which is shown in FIG. 3, relative to the clamping plate 2 into a gripping position by a compressive force being applied. The gripping sleeve 3 is shown in a cross-sectional view in FIG. 4.

The gripping sleeve 3 has a plurality of gripping legs 10, the gripping legs 10 engaging in a play-free manner on the shaft 8 in the gripping position of the gripping sleeve 3. In the embodiment described, the gripping legs 10 bear frictionally against the shaft 8 in the gripping position of the gripping sleeve 3 such that any play between the clamping flange 1 and the shaft 8 is ruled out in the gripping state. In the gripping position, the clamping flange 1 can, then, no longer be displaced in the axial direction relative to the shaft 8 or rotated about the shaft 8. By contrast, in the release position, there is no frictional connection between the shaft 8 and the clamping flange 1, and therefore, the clamping flange 1 can readily be displaced in the axial direction on the shaft 8 or can be rotated thereabout. It is pointed out at this juncture that it is not absolutely necessary for the gripping legs 10 to bear frictionally against the shaft 8 in the gripping state.

The gripping legs 10 extend from an annular part 11, which is provided at a rear end of the gripping sleeve 3, forward in the axial direction to the front side 7 of the clamping flange 1. The annular part 11 has a greater wall thickness than the gripping legs 10, the gripping legs 10 having a smaller wall thickness in a central region 12 than in a region 13 in the vicinity of the end. This leads to the gripping legs 10 acting as spring legs, the gripping legs 10 automatically springing back from a gripping position into a release position releasing the clamping force when the gripping sleeve 3 is relieved of load. After the gripping sleeve 3 is relieved of load, the clamping flange 1 can therefore be displaced again in a simple manner on the shaft 8 or can be removed from the shaft 8, with the springing back of the clamping legs 10 into the release position leading to an increase in the play between the clamping flange 1 and the shaft 8.

The gripping legs 10 are arranged at equal spaced around the circumference of the gripping sleeve 3, and adjacent gripping legs 10 are separated from one another by slot-shaped recesses 14 which extend in the axial direction and bulge in the central region. The distribution of the gripping legs 10 around the circumference of the gripping sleeve 3 leads to automatic centering of the clamping flange 1 on the shaft 8 during the transfer of the gripping sleeve 3 into the gripping position, each gripping leg 10 bearing in the region 13 of the vicinity of the end against the shaft 8.

The free end of each gripping leg 10 has an inner surface 15 which is designed for bearing in a play-free manner against the shaft 8 in the gripping state. The inner surface 15 extends in the axial direction substantially parallel to the longitudinal axis of the shaft 8 and is curved in a circular manner in the circumferential direction in order to permit a substantially play-free bearing against a circumferential surface 15a of the shaft 8 in the gripping state. Furthermore, a sufficient holding force can thus be transmitted via the inner surface 15 so as to form a frictional connection to the shaft 8 in the gripping state.

When a clamping nut (not illustrated) is screwed onto the shaft 8 of the wheel balancing machine, the clamping flange 1 is pressed by centering bolts, which are inserted into the recesses 4 in the clamping plate 2, against the rim of a vehicle wheel to be balanced, the rim being clamped between a flange of the shaft 8 of the wheel balancing machine and the centering bolts which are connected to the clamping plate 2. In order to center the rim on the shaft 8, the centering means described at the beginning can be provided. When the rim of the vehicle wheel is placed against the flange of the shaft 8 of the wheel balancing machine by means of the centering bolts, a quick-acting clamping nut is screwed further onto the shaft 8, which leads to an increase in the clamping force. As a result, the gripping sleeve 3 is pressed forwards in the direction X relative to the clamping plate 2 counter to the spring force of the springs 4.

The release position of the gripping sleeve 3 that is illustrated in FIG. 3, is initially a distance between a conical outer surface 16 of each gripping leg 10 and a complementarily designed conical inner surface 17 of the centering extension 9. As the gripping sleeve 3 is increasingly advanced, the conical surfaces 16, 17 move toward each other and finally enter into form-fitting contact. By means of the conically designed surfaces 16, 17, a further advancing of the gripping sleeve 3 results in the gripping sleeve 3 being compressed in the front region, and therefore, in a reduction in the play between the inner surfaces 15 of the gripping legs 10 and the circumferential surface 15a of the shaft 8 until the inner surfaces 15 of the clamping legs 10 bear in a form-fitting manner against the circumferential surface 15a of the shaft 8. As a result, the clamping flange 1 is centered in a play-free manner on the shaft 8 via the gripping sleeve 3. As a function of the strength of the clamping force, when the clamping force is further increased, a frictional connection between the inner surfaces 15 and the circumferential surface 15a of the shaft 8 is finally formed. An absolutely play-free centering of the clamping flange 2 on the shaft 8 of the wheel balancing machine is achieved as a result, and clearly assists the centering of the wheel which is to be balanced.

The spring force of the springs 4 provided as the spring means leads to the gripping sleeve 3, when relieved from the clamping force, being pushed away from the clamping plate 2 counter to the direction X and being automatically transferred again from the gripping position into the release position illustrated in FIG. 3 such that the clamping flange 1 can be pulled off the shaft 8 in a simple manner. In this case, the gripping sleeve 3 is held in the axial direction on two abutments 18 of the centering extension 9 counter to the spring force of the springs 4. The abutments 18 serve to limit the spring deflection of the springs 4 when the gripping sleeve 3 is relieved from the clamping force, and act as a means of securing the gripping sleeve 3 against rotation.

In this case, the slot-shaped recess 14 between two adjacent gripping legs 10 forms a guide portion for the abutment 18, the recess 14 having a cross-sectional tapering 19 at the outer end of the central region 12 of the adjacent gripping legs 10. Each abutment 18 bears against two adjacent gripping legs 10 in the region of the cross-sectional tapering 19. The abutments 18 are farmed by bolts inserted from the outside on opposite sides through the centering extension 9 into the region of the central aperture 6. In principle, it is also possible for the bolts to be screwed in, which makes it possible for the gripping sleeve 3 to be released from the clamping flange 1 and exchanged when the need arises as a function of the state of wear.

On a rear side 20 of the clamping flange 2, the gripping sleeve 3 has an annular flange 21, the annular flange 21 having an outer bearing surface 22 for a bearing surface of a clamping nut. An annular projection 23 arranged coaxially with respect to the central aperture 6 is provided on the rear side 20 of the clamping flange 1, an annular depression 24 in the clamping plate 2 with a bearing surface 25 for an inner surface 26 of the annular flange 21 being formed by the projection 23. The springs 4 are arranged in an equally distributed manner around the circumference of the depression 24 in the region of the depression 24 and are inserted into blind holes 27 in the clamping plate 2.

As is apparent from FIG. 3, in the release position, the annular flange 21 is held by the springs 4 with an annular gap being formed at a distance from the bearing surface 25. The annular flange 21 is held in the depression 24 in a displaceable manner in the axial direction. The distance between the inner surface 26 of the annular flange 21 and the bearing surface 25 of the clamping plate 2 defines the maximum adjustment distance by which the gripping sleeve 3 can be moved forwards in the direction X under the action of a clamping force. As can be seen from a comparison of the distance between the inner surface 26 and the bearing surface 25, on the one hand, and the distance between the conical outer surface 16 and the conical inner surface 17, on the other hand, it is generally not necessary to move the gripping sleeve 3 forwards by the maximum adjustment distance in order to center the clamping flange 1 in a play-free manner on the shaft 8.

When the need arises, the invention furthermore makes it possible to combine the features mentioned in the claims and/or the previously described features disclosed in the drawing with one another although this is not described in detail. The invention is not restricted to the illustrated and described embodiment of the clamping flange 1.

1-16. (canceled)

17. Clamping flange for pressing a rim of a vehicle wheel against a flange of a shaft of a wheel balancing machine, comprising:
a clamping plate having a plurality of recesses for receiving centering bolts, and a central aperture for mounting onto the shaft of the wheel balancing machine, and
a gripping arrangement for centering of the clamping flange on the shaft of the wheel balancing machine,
wherein the gripping arrangement has a gripping sleeve mounted in the central aperture in a manner displaceable in an axial direction relative to the clamping plate,
wherein the gripping sleeve is displaceable from a release position into a gripping position by an applied compressive force acting in the axial direction,
wherein the gripping sleeve is mounted in the gripping position in a play-free manner on the shaft and in aperture of the clamping plate,
wherein an annular centering extension is arranged coaxially with respect to the central aperture on a front side of the clamping plate and forms a guide for the gripping sleeve, and
wherein the gripping sleeve has a plurality of gripping legs, the gripping legs being arranged between the centering extension and the shaft, and in the gripping position of the gripping sleeve, bearing at least in some sections in a play-free manner against the shaft, the gripping legs being uniformly spaced around the circumference of the gripping sleeve and adjacent gripping legs being separated from one another by slot-shaped recesses that extend in the axial direction.

18. Clamping flange according to claim 17, wherein the gripping legs extend from an annular part of the gripping sleeve in the axial direction toward a front side of the clamping plate.

19. Clamping flange according to claim 17, wherein a free end of each gripping leg has an inner surface for bearing in a play-free manner against the shaft in the gripping position.

20. Clamping flange according to claim 17, wherein each gripping leg has a conical outer surface for bearing in a play-free manner against a conical inner surface of the centering extension in the gripping position.

21. Clamping flange according to claim 17, wherein at least one spring means is supported on the clamping plate and acts counter to movement of the gripping sleeve toward said gripping position.

22. Clamping flange according to claim 21, wherein the gripping sleeve is held in the axial direction on at least one abutment of the centering extension counter to the spring force of the spring means in said release position.

23. Clamping flange according to claim 22, wherein a slot-shaped recess between adjacent gripping legs forms an axial guide for the abutment, the recess having a cross-sectional tapering, and the abutment bearing against two adjacent gripping legs in the region of the cross-sectional tapering in the release position of the gripping sleeve.

24. Clamping flange according to claims 22, wherein at least two abutments are provided, and the abutments are formed by bolts extending inwardly at opposite sides of the centering extension into a region of the central aperture.

25. Clamping flange according to claim 17, wherein the gripping sleeve has an annular flange on a rear side of the clamping plate, the annular flange having an outer bearing surface for a bearing surface of a clamping nut which can be screwed onto the shaft of the wheel balancing machine.

26. Clamping flange according to claim 25, wherein a plurality of spring means are supported against the clamping plate and act counter to the annular flange.

27. Clamping flange according to claim 25, wherein a rear side of the clamping plate has an annular projection which is arranged coaxially with respect to the central aperture, and which forms an annular depression with a bearing surface for an inner surface of the annular flange.

28. Clamping flange according to claim 27, wherein the inner surface of the annular flange is spaced apart from the bearing surface of the depression with an annular gap being formed between the gripping sleeve and the clamping plate in the release position of the gripping sleeve.

29. Clamping flange according to claim 27, wherein the spring means are arranged within the depression equally spaced in the circumferential direction.
